(19) United States
(12) Patent Application Publication
(10) Pub. No.: US 2004/0091629 A1
(43) Pub. Date: May 13, 2004

(54) Coated substrate with metallic surface impression, method for adhesively coating substrates with corrosive optical layers and use of said coated substrate and products obtained from a method for adhesively coating with corrosive optical layers

(76) Inventors: Klaus-Peter Konig, Gauting (DE); Lennart Zlendelin, Paarp (SE); Michael Kaessmann, Munchen (DE)

Correspondence Address: J Peter Fasse, Fish & Richardson, 225 Franklin Street, Boston, MA, 02110-2804, US

(21) Appl. No.: 10/276,389

(22) PCT Filed: May 16, 2001
(86) PCT No.: PCT/EP01/05602

(30) Foreign Application Priority Data
May 16, 2000 (DE) 1002386.2

(51) Int. Cl. B05D 1/36; B05D 3/02

(52) U.S. Cl. 427/407.1; 427/376.1; 427/404; 427/385.5

(57) ABSTRACT

A coated substrate giving a metallic surface impression is described which is obtained from a process in which

(a) at least one base varnish layer is applied to the surface of the substrate,

(b) the at least one base varnish layer is dried thoroughly following its application,

(c) a corrodible optical layer is applied,

(d) the substrate coated according to the preceding steps (a), (b) and (c) is heated, and finally

(e) at least one protective varnish layer is applied.

The corrodible optical layer is a metallic layer and/or the whole method is carried out at temperatures below 120° C.

The invention relates to coated substrates giving a metallic surface impression or rather coated substrates with a metallic surface obtained from methods for adhesively coating substrates with corrodible optical layers, processes of this nature, as well as uses of the process products manufactured using the aforementioned methods or rather the coated substrates giving a metallic surface impression obtained in such a way.

DE 40 09 857 A1 and DE 40 09 858 describe a varnishing process known as the basecoat/clearcoat process. In this process, metallic base varnishes (corrodible optical layers), for example, which contain polymer resins, are applied to phosphated steel sheets using a normal commercial electrophoretic varnishing method and a normal commercial filler. The applied base varnishes are dried (not baked or burned on) . Then a normal commercial clear coat is applied and the two varnish coatings are baked at 140° C.

It has been a longstanding practice to optically enhance or finish any substrates, particularly wood- or plastic-based substrates, so as to achieve an overall metallic look on the outside. Such external effects are achieved by applying specific coatings to the substrates. In this method, these substrate coatings must, on the one hand, satisfy high optical standards, i.e., create a homogeneous, esthetically pleasing overall impression without cloudy spot images and shades, as well as a glossy or, ideally, even reflecting surface. On the other hand, in addition to satisfying a set of visual standards, the coatings must also satisfy functional requirements. Of interest here are in particular the adhesive strength of the coating(s) applied to the substrate or rather the resistance of the coating to oxidizing or corroding external influences.

Many state-of-the-art methods of applying corrodible optical layers, especially metallic coatings, to substrates, such as to plastics, are known. Methods of metal-coating plastics include, for example, plastic galvanization, spray application of suitable solutions, or vapor deposition in a vacuum of metals onto a plastic-based substrate. Such coatings are intended, among other things, to also protect the substrate, for example to protect plastics against the effects of solvents, oil and/or moisture. In particular, however, they result in substantial cost and weight savings in comparison to the use of metallic substrates in cases in which an overall metallic impression is desired.

However, when coating is performed with corrodible optical solutions, it is important to ensure that adhesion of the corrodible optical layer to the substrate as well as minimal susceptibility to corrosion is guaranteed. In the state of the art, these requirements are met through the use of protective varnishes, especially clear protective varnishes, but also dyed protective varnishes, to which a hardener component is generally added prior to application onto the corrodible optical layer. In this method the hardener component is added to the protective varnish in advance, so as to accelerate the hardening process of the resin component in the protective varnish, but also to increase for example the resistance of the coated substrate to abrasion, gasoline or perfumes. Although this state-of-the art process has the effect that the susceptibility to corrosion of the corrodible optical layer is delayed by the application of the protective varnish/hardener mixture, it proves to be unsuitable in any situation in which imprecision or even damage to the protective varnish layer occurs during application of said layer. Such damage, e.g., in the form of tears or flaking, is then followed by the undesirable phenomenon known as “corrosive spread.” When this occurs, corrosion spreads from the damaged portion of the protective varnish layer along the optical corrodible layer and, within a very short period of time, leads to considerable optical damage to the coated substrate and, ultimately, to its being rendered unusable.

With respect to the current state-of-the-art procedure for applying the protective varnish as described, it was also observed that moisture or gases are even diffused through the substrate material itself, from the uncoated side to the externally applied corrodible optical layer, where they can also trigger corrosion phenomena. This problem associated with substrate finishing according to the state of the art is well-known for various metal as well as for plastic substrates. In turn, it is only possible to counteract this phenomenon by incurring the significant cost of expensively coating the undersides and interior surfaces of the substrate. The inadequate options, according to the state of the art, for conferring corrosion protection on substrates with corrodible optical layers have thus far resulted in the inability to use substrates with coatings susceptible to corrosion in exterior applications.

Furthermore, the coatings containing corrodible optical materials and/or the corresponding coating processes known currently are characterized by considerable problems in terms of their adhesive strength, especially in terms of their adhesion to a metallic corrodible layer on the substrate. Although the substrate is routinely treated with a base varnish layer prior to the application of a metallic corrodible layer, such as a silver layer, to improve the adhesive strength of the metallic corrodible layer, an improvement of adhesive strength is, according to the state of the art, achieved only if the metallic corrodible layer is applied before the base varnish layer has fully dried. Although this process does produce satisfactory results with respect to adhesive strength, it proves to be disadvantageous in that, during regularly performed heat treatment after application of the protective varnish layer(s) onto the metallic corrodible layer, the latter is optically impaired by, for example, white spots or ripples. However, such effects are not desirable, especially with mirror-coating.

Consequently, it is an object of the invention to provide substrates with coatings that give a metallic overall impression due to the application of corrodible optical materials, as well as suitable processes to produce said substrates, whereby it must be guaranteed that the coated substrates or processes to produce such coated substrates ultimately exhibit the best possible adhesion of the coatings to the substrate, minimize the corrodibility of the layer, eliminate optical impairment as a result of production factors, and whereby a process-optimized approach to the production of the substrate is desired.

The aforementioned objectives are solved by claims 1, 8, 18 and 19 of the invention.

According to claim 1, a coated substrate giving a metallic surface impression, i.e., an effect that gives the substrate a generally metallic appearance, can be claimed when it is obtained by a method in which (a) at least one base varnish layer is applied to the surface of the substrate, (b) wherein the least one base layer of varnish is dried thoroughly after being applied, (c) a corrodible optical layer is applied, (d) the substrate coated according to the preceding steps (a), (b) and (c) is heated, and finally, according to (e), at least one protective varnish layer is applied, wherein a single-component protective varnish, especially a nano-varnish, is used as the protective varnish layer, or a two-component protective layer containing protective varnish and a hardener component is applied as a mixture.

The present invention is based on the discovery that, following application of the corrodible optical layer onto the substrate with a completely dried base varnish layer, additional or secondary heating according to process step (d) ensures the adhesion of the corrodible optical layer to the varnished substrate. The temperature during this heating step does not exceed 120° C, and preferably 100° C, or even 800° C. Without being tied to a scientific theory, the heating according to process step (d) appears to result in a brief softening of the base varnish. Without the heating process according to (d), sufficient adhesion of the corrodible layer to the substrate with dried base varnish cannot be achieved.

Ultimately, this discovery by the inventors not only leads to optimal corrosion protection, but also satisfies the requirements for adhesion of the corrodible optical layer to the substrate and/or adhesion of, for example, the protective layer(s) of varnish to the corrodible optical layer, without incurring, according to this method, the additional cost of applying multiple solutions, and without optical impairment.

Substrates coated in this manner can be wood, plywood, plastic, or metal. The substrates coated according to the invention will feature in their coating one or more base layers of varnish, preferably with a layer thickness of between 5 and 30 μm. One or more corrodible optical layers with a layer thickness of 0.01 to 1 μm, such as a silver layer followed by a copper layer, can be applied to said base layers. The one or more protective layers of varnish, with one being the minimum, that has/have been applied to the corrodible optical layer(s) preferably has/have a layer thickness of 5 to 50 μm, especially 15 to 50 μm. In general, however, layers can be up to 100 μm thick. Also, such thicknesses of the aforementioned layers of typically less than 50 μm in no way compromise the optical standards required from the coated substrate.

The base varnish with which the substrate is treated according to process step (a) serves as a bonding agent between the carrier material and the corrodible optical film and, if applicable, as a protection against diffusion. In this sense, it is advantageous if the base varnish exhibits a certain degree of water compatibility water and wettability. All usual commercial two-component varnishes, such as Durodur® (3051D-003, Morton or Rohm & Haas, containing the hardener 5409), can be used as base varnishes. However, single-component varnishes, such as the so-called nano-varnishes that contain nano-particles (also referred to as hybrid varnishes based on sol-gel technology), can also be used. The single-component varnishes or the two-component varnishes containing a hardener can be dried by means of air or kiln drying and/or by means of UV hardening, for example by admixture of photo-active components.

The base varnish layer covers the substrate and improves the adhesion of the corrodible optical layer to the substrate. Irregularities or rough areas on the substrate should be covered to the greatest extent possible. The application of the base varnish can be repeated one or several times, if necessary.

Spraying methods are especially well-suited for application of the base varnish layer according to process step (a). However, immersion methods are also used, as well as what is known as “flow coating” of the substrates. According to process step (b), drying of the base varnish layer(s) can take the form of air or kiln drying and/or UV hardening for a duration of at least 5 minutes before the next process step—whether it consists of another application of the base varnish or, according to process step (c), the application of the corrodible optical layer—takes place. The duration and/or temperature of the air or kiln drying depends, in this process, on the substrate as well as on the specific binder in the base varnish. Typically, a drying period of between 5 minutes and 10 hours is selected, depending on the substrate, the drying temperature, and the base varnish. Drying times of between 1 and 2 hours are preferred. Drying temperatures are preferably between 20 and 120° C., especially preferably between 70 and 100° C.

Within the scope of the present invention above all those coated substrates are claimed whose corrodible optical layer is a metal layer. Special preference is given to silver layers, so that substrates coated in accordance with the invention may include especially mirrors with plastic or wooden cores or mirrored objects for any use. However, metallic effect varnishes can also be contained in or form the corrodible optical layer. These metallic effect varnishes typically feature metal particles.

Also claimed within the scope of the present invention are methods for coating substrates with corrodible optical layers, wherein (a) at least one base varnish layer is applied to the surface of the substrate, (b) the at least one base varnish layer is dried thoroughly, (c) a corrodible optical layer is applied, (d) the substrate coated according to the preceding steps (a), (b) and (c) is heated, and finally, according to (e), at least one single-component protective varnish layer, especially a so-called nano-varnish, and/or at least one two-component (i.e., varnish and hardener) protective varnish layer is applied.

In a preferred execution of process step (e), at least one layer-forming agent without a hardener component, containing at least one protective varnish (component A), or a layer-forming agent without a protective varnish, containing at least one hardener component (component B), can be initially applied to the one or more corrodible optical layer, with one being the minimum, in a process step (e1) before, in a process step (e2), at least one two-component mixture containing at least one protective varnish (component A) and at least one hardener component (component B), as a protective varnish layer, and, if applicable, a single-component protective varnish (such as a nano-varnish), is applied to said corrodible optical layer. Conducting the process in this manner also ensures that the corrodible optical layer adheres to the substrate to the best degree possible. Such an approach results in the netting or bonding of the layers applied in accordance with (e1) and (e2) through the corrodible optical layer extending all the way to the base-varnished substrate. Coated substrates obtained by conducting the process in this preferred manner are also the object of the invention.

Thus, according to the preferred execution, a protective varnish, such as one containing a resin component of the preferred type described below, and containing a hardener, also such as the preferred type described below, are used in process step (e) or process step (e2) . Natural resins or synthetic resins can be used as components of the protective varnish. A list, which is by no means exclusive, of, for example, synthetic resins that can be used as bonding agents in the protective varnish can include:

phenol resins, amine resins (such as benzoguanamine, urea, and melamine resins), alkyd resins, polyvinyl acetate, epoxy resins, polyurethane resins, polyester resins containing colophonium-modified phenol resins, chlorine rubber, chlorinated polypropylene, cyclorubber, ketone resins, or acrylate resins. In the protective varnishes the binders are combined with the corresponding solvents and/or dilution agents; any professional will know which combinations of solvents and/or dilution agents and binders can be applied as protective varnishes, and in which form they can be applied.

The following hardeners in particular can be used as hardeners for the protective varnish layer: hydrogen chloride, peroxides or polyfunctional compounds, such as polyamines, polyepoxies, or polyisocyanates.

If, according to a preferred embodiment, the process step (e1) is performed prior to the application of the two-component mixture or of the single-component protective varnish as a protective varnish layer (in the preferred execution process step (e) corresponds to process step (e2)), at least one protective varnish, such as one of the aforementioned protective varnishes, which does not contain hardener component(s) but, if applicable, may also contain other substances, is preferably chosen as a layer-forming agent, or one or more hardeners is/are chosen in this regard for the protective layer as layer-forming agents without the layer-forming agent being permitted to contain protective varnishes but containing other substances, if applicable, such as one of the aforementioned hardeners.

According to process step (e) or (e2) in the preferred execution, either a two-component mixture is applied as a protective varnish layer, which mixture contains a protective varnish and at least one hardener component, or a single-component varnish (such as a nano-varnish) is applied. In this case, the function of the hardener component is to enable the applied varnishes to harden into stable surface layers. The acceleration of the hardening of varnishes by the hardener component can be based on acceleration of the polymerization, polyaddition or polycondensation of the resin component in the varnish. Clear-coat varnishes are especially preferred.

The protective varnishes and/or hardeners used to coat a substrate according to process steps (e1) and (e2) can be identical or different. If necessary, process steps (e1) and (e2) can be repeated one or more consecutive times. For example, process step (e1) can be repeated two or more times with an identical or with one or more different protective varnishes before the mixture is applied in accordance with process step (e2) to form the protective varnish layer.

It is also preferred to insert an air and/or kiln drying step following the application of the protective varnish layer(s) or following process step (e1), although UV hardening of the layer is also conceivable. The drying step is likely to be especially advantageous following process step (e1) if the layer-forming agents in this layer contain at least one protective varnish, but no hardener component. The duration of the drying steps according to process step (e1), (e2) or (e) should preferably be at least 1 minute or, especially, 5 to 15 minutes. The temperature and duration of drying depend on the substrate and on the composition of the protective varnish and/or the duration of drying, whereby the drying temperature should be lower than 120° C., and typically between 50 and 80° C. Such air and/or kiln drying is especially preferred following application of the protective varnish layer. Typically, a higher temperature is chosen for hardening of the base varnish layer than for hardening of the protective varnish layer and/or following process step (el), especially a temperature that is typically 10 to 20° C. higher.

The substrates treated in accordance with the invention are preferably wood, plywood, metal, or plastic. The invention can however be applied to all woods, as well as to veneered materials. A list, by no means exclusive, of plastics coatable in accordance with the invention includes acrylonitrile-butadiene-styrene (ABS), polystyrene (PS), polypropylene (PP), polycarbonate (PC), polymethylmethacrylate (PMMA), polyamide (PA), polyvinylchloride (PVC), polybutylenterephthalate (PBTB), polyphenylene oxide(PPO), polyurethane RIM (PUR-RIM), R-RIM, PP-EPDM, GF-UP, SMC, and BMC.

In one embodiment of the method according to the present invention, the corrodible optical layer in process step (c) is applied to the substrate with one or more layers underneath it, such as one or more base varnish layers, using vacuum evaporation, spraying and/or galvanization methods. The vacuum evaporation method can also be performed under high-vacuum conditions. Metallic effect varnishes can also be applied as a corrodible optical layer.

The corrodible optical layer is preferably a metallic layer or a metallic film. In principle, all metals usable for coating purposes can be applied. However, the application of a thin silver layer, which can produce mirror effects, is preferred. The application of the metal layer, such as a silver layer, is preferably accomplished by means of chemical spray metallization in which special spray guns are connected to spray solution containers. This metallization is typically performed with special two-component guns. Silver salt is sprayed from one gun nozzle and a reduction solution from the other. The spraying process lasts between 15 and 90 seconds and, if necessary, is followed by a rinsing step and finally, if necessary, by a drying step. The temperature during the subsequent heating step preferably does not exceed 120° C., preferably does not exceed 100° C., or even 80° C.

To produce special color effects, the protective varnish(es), which are typically transparent, can be tinted. At least one color component is selected, depending on the desired tone of the coated substrate, so that, for example, brass, gold or copper tones of the coated substrate can be achieved. Especially preferred is the addition of such color components that can eliminate the optically disturbing yellow tone of a glossy silver layer and produce a chrome-like sheen. In particular, Zapon dyes and/or optical brighteners may be used as color components. If at least one protective varnish is used as a layer-forming agent in accordance with process step (el), the color component(s) and/or the optical brightener(s) is (are) preferably incorporated into the protective varnish for the protective layer.

In a further preferred execution, a two-component protective varnish, for example, containing colorants for tinting purposes is applied in accordance with process step (e), followed by the addition of a protective varnish, such as a two-component protective varnish, as an additional clear-coat varnish.

Accordingly, the object of the present invention is also such a substrate giving a metallic surface impression that has been coated using one of the methods of claims 7 to 17. The coated substrates according to one of the claims 1 to 6 or a substrate giving a metallic surface impression according to claim 18 are used, in particular, in all applications in which a generally solid metal impression is desired. Examples include the use of such coated substrates in souvenir, Christmas tree, sanitary, decoration, cosmetic, household, electronic, and/or toy articles. Such coated substrates are also used in the entire field of components used in automobile manufacturing. Aluminum profile elements represent another field of application. The substrates coated in accordance with the invention can be used in both internal and external areas. The use of these coated substrates is especially preferred in cases in which reflecting effects are desired.

The results, superior to the current state of the art, in substrates giving a metal surface impression treated in accordance with the invention are also achieved when no protective layer(s), i.e., (a) layer(s) that contain(s) either hardeners and, in this case, no protective varnish, or protective varnish and, in this case, no hardener is (are) applied, but instead one or more protective varnish layers, each containing, in addition to other substances, if applicable, at least one protective varnish, at least one hardener component, as well as at least one other functional substance which exerts a retarding effect on the hardening process, is (are) applied directly to the corrodible optical layer.

This can consist of at least one retardant, at least one softener and/or one oil component. The use of a so-called elastic protective varnish is also conceivable in this regard. Retardants, for example, cause the polymerization of the protective varnish with (a) hardener component(s) to be retarded. In this case, penetration of the protective varnish into the layers underneath is also possible, so that adhesive strength and protection from corrosion are also guaranteed. In addition, it is also advantageous to initially apply to the corrodible optical layer at least one protective layer, containing either hardeners without protective varnish or, conversely, protective varnish without hardeners, and then to apply at least one protective varnish layer containing hardener and protective varnish, as well as at least one additional component that retards hardening, and finally, at least one additional protective varnish layer containing at least one hardener component and at least one protective varnish, whereby the last-mentioned protective varnish layer hardens quickly.

Thus, the present invention also encompasses all coatings that include at least one corrodible optical layer which is coated with at least one additional retarding, hardening layer, whereby the retarding, hardening layer is capable of penetrating at least one corrodible optical layer underneath, such as a so-called nano-varnish. Consequently, the present invention also encompasses all methods used to preserve such coated substrates and which feature a corrodible optical layer, in that at least one corrodible optical layer is initially applied, followed by application of a layer-forming agent, which can at least penetrate the corrodible optical layer before it hardens.

The present invention is explained in greater detail with the following example:

### EXAMPLE

(a)

The present example describes a method for mirror-coating plastic surfaces with a coating containing a corrodible optical layer, which is adhesive and has preservative properties.

First, a 1 m×1 m plate made of ABS plastic was dipped into a reactor containing water-sensitive base varnish (two-component varnish, Morton Company, USA (or Rohm & Haas) Durodor 3051D-0030, with hardener 5409; process step (a)). A smooth, glossy varnish surface of the ABS plastic plate was produced using suitable mechanical preparations known to the professional. The base varnish layer was dried for 1.5 hours at a kiln temperature of 80° C (process step (b)).

Following the application of the base varnish layer, the base varnish was sensitized by processing it with a sensitizer containing tin in concentrations in the ppm range. This was followed by an intermediate rinsing step.

In the next step, a mixture of silver salt solution and reducing agents was sprayed onto the base-varnished plastic plate in a wetting process, thus coating its surface with a glossy, silver reflecting layer. The application of the metallic layer was followed by a rinsing step and, finally, by drying the applied layer of metallic silver solution with warm blast air. This was followed by a ten-minute subsequent warming step at a temperature of 70° C. (process step (d)).

To protect the corrodible optical layer, in this case the metallic silver layer, against any damaging external influences, a clear varnish (Helacryl®, Spiess & Hecker) containing a hardener component (Permacron) was applied to the metallic layer at a layer thickness of 10 μm by spraying the plastic plate (process step (e)). The plastic plate coated in this manner was subsequently subjected to a 60 minute kiln drying process at temperatures ranging from 40 to 60° C.

Finally, the 1 m×1 m coated plastic plate with reflecting properties obtained according to (a) was subjected to adhesion and corrosion tests.

(b)

To this end, a grid-section test known to any professional was first performed. A close-meshed grid was scratched into the reflecting and varnish-protected layer with a sharp tool. Then an adhesive strip was used to test the adhesion of the individual layers to one another and to the plastic substrate. To this end, the scratched grid was covered with the adhesive strip. After applying external pressure to the adhesive strip and allowing it to adhere for approximately 1 minute, the adhesive strip was abruptly removed from the point of adhesion. No traces of either protective varnish or the metallic silver layer were found on the adhesive strip.

In contrast, in a comparison test with a coated substrate, which also featured a dried base varnish layer covered by a silver layer, but which was not—as provided by the invention—heated in a process step (d) following its application (as described initially, substrates obtained from a method without process step (d) are known according to the current state of the art), a large number of adhered portions of the layer were observed on the adhesive strip. These included portions of the protective varnish layer and, in particular, portions of the silver layer that had separated from the base-varnished substrate.

In conclusion, this means that the coated plastic plate obtained in accordance with the invention or a plastic substrate (in this case, a plate) treated in accordance with the inventive method showed no signs of adhesion problems. Both the individual layers among one another and the adhesion of the entire coating to the substrate proved to be exceptionally stable in this test, while the comparison test revealed the poor adhesion strength of the protective varnish layer and/or of the overall coating on the substrate.

(c)

Subsequently, the plastic plate treated in accordance with (b) and with the surface damage caused by scratching of the grid was kept in a humid room, i.e., under highly corrodible conditions, for a period of 15 days. During this process, the plastic plate coated in accordance with the invention exhibited no impairments in color or buckling in the areas adjacent to the grid.

1. Coated substrate giving a metallic surface impression, obtained from a method in which
(a) at least one base varnish layer is applied to the surface of the substrate,
(b) the at least one base layer of varnish is dried thoroughly after being applied,
(c) a corrodible optical layer is applied,
(d) the substrate coated according to the preceding steps (a), (b) and (c) is heated, and finally
(e) at least one protective varnish layer containing a single-component protective varnish, such as a nano-varnish, and/or a two-component protective varnish is applied,
characterized in that the corrodible optical layer is a metallic layer.

2. Coated substrate, especially according to claim 1, obtained from a method in which
(a) at least one base varnish layer is applied to the surface of the substrate,
(b) the at least one base varnish layer is dried thoroughly following its application,
(c) a corrodible optical layer is applied,
(d) the substrate coated according to the preceding steps (a), (b) and (c) is heated,
(e1) a layer-forming agent containing either at least one component A or at least one component B is applied to the at least one corrodible optical layer, whereby component A is a protective varnish and component B is a hardener component, and finally, in a process step
(e2) at least one protective varnish layer containing a single- or two-component protective varnish is applied, characterized in that the corrodible optical layer is a metallic layer.

3. Coated substrate according to claim 1 or 2, characterized in that the metallic layer is a silver layer.

4. Coated substrate according to one of claims 1 to 3, characterized in that the substrate is wood, plywood, plastic, or metal.

5. Coated substrate according to one of the above claims, characterized in that the metallic layer exhibits a layer thickness of 0.01 to 1 μm and the protective varnish layer(s) together exhibit a layer thickness of 5 to 50 μm.

6. The substrate according to one of the above claims, characterized in that the base varnish layer has layer thickness of 5 to 30 μm.

7. A method for adhesively coating substrates with corrodible optical layers in which
(a) at least one base varnish layer is applied to the substrate,
(b) the at least one base varnish layer is dried thoroughly following its application,
(c) a corrodible optical layer is applied,
(d) the substrate coated according to the preceding steps (a), (b) and (c) is heated, and finally
(e) at least one protective varnish layer containing a single-component protective varnish, such as a nano-varnish, and/or a two-component protective varnish is applied
characterized in that the corrodible optical layer according to (c) is a metallic layer.

8. Method, especially according to claim 7, in which
(a) at least one base varnish layer is applied to the substrate,
(b) the at least one base varnish layer is dried thoroughly following its application,
(c) a corrodible optical layer is applied,
(d) the substrate coated according to the preceding steps (a), (b) and (c) is heated,
(e1) a layer-forming agent containing either at least one component A or at least one component B is applied to the at least one corrodible optical layer, wherein component A is a protective varnish and component B is a hardener component, and finally, in a process step
(e2) at least one protective varnish layer containing a single-component protective varnish, such as a nano-varnish, and/or a two-component protective varnish is applied
characterized in that the corrodible optical layer according to (c) is a metallic layer.

9. Method according to claim 7 or 8, characterized in that the metallic layer is a silver layer.

10. Method according to one of claims 7 to 9, characterized in that the drying of the base varnish layer according to process step (b) is air or kiln drying and/or UV hardening of at least 5 minutes.

11. Method according to one of claims 7 to 10, characterized in that an air and/or kiln drying of the protective varnish layer or of the layer applied in accordance with process step (e1) of at least 1 minute in duration or a UV hardening of the protective varnish layer takes place.

12. Method according to one of claims 7 to 11, characterized in that the substrate is wood, plywood, metal, or plastic.

13. Method according to one of claims 7 to 12, characterized in that the substrate is a plastic, selected from the class [consisting of] acrylonitrilebutadiene-styrene (ABS), polystyrene (PS), polypropylene (PP), polycarbonate (PC), polymethylmethacrylate (PMMA), polyamide (PA), polyvinylchloride (PVC), polybutylenterephthalate (PBTB), polyphenylene oxide(PPO), polyurethane RIM (PUR-RIM), PP-EPDM, and GF-UP.

14. Method according to one of claims 7 to 13, characterized in that the metallic layer according to (c) is applied by means of vacuum evaporation, spraying and/or galvanization methods.

15. Method according to claim 14, characterized in that the metallic layer is applied by means of a metal spray reduction process.

16. Method according to one of claims 7 to 15, characterized in that, according to process step (d), heating is performed at a temperature of between 50 and 80° C., preferably for at least 10 minutes.

17. Method according to one of claims 7 to 16, characterized in that a mixture is applied as a protective varnish that contains, in addition to protective varnish and hardener, at least one tinting component.

18. Substrate giving a metallic surface impression, characterized in that it is treated in accordance with a method according to one of claims 7 to 17.

19. Use of a coated substrate according to one of claims 1 to 6 or of a substrate according to claim 18 as a mirror, reflecting material, toy, sanitary, souvenir, household, electronic, decorative and/or Christmas tree ornament article, aluminum profile element, or as a component in automobile manufacturing.

20. Coated substrate giving a metallic surface impression, obtained from a method in which
(a) at least one base varnish layer is applied to the surface of the substrate,
(b) the at least one base layer of varnish is dried thoroughly after being applied,
(c) a corrodible optical layer is applied,
(d) the substrate coated according to the preceding steps (a), (b) and (c) is heated, and finally
(e) at least one protective varnish layer containing a single-component protective varnish, such as a nano-varnish, and/or a two-component protective varnish is applied,
characterized in that a temperature of 120° C is not exceeded in any process step.

21. Coated substrate, especially according to claim 1, obtained from a method in which
(a) at least one base varnish layer is applied to the substrate,
(b) the at least one base varnish layer is dried thoroughly following its application,
(c) a corrodible optical layer is applied,
(d) the substrate coated according to the preceding steps (a), (b) and (c) is heated,
(e1) a layer-forming agent containing either at least one component A or at least one component B is applied to the at least one or more corrodible optical layers, wherein component A is a protective varnish and component B is a hardener component, and finally, in a process step
(e2) at least one protective varnish layer containing a single-component or a two-component protective varnish is applied,
characterized in that a temperature of 120° C. is not exceeded in any process step.

22. Coated substrate according to one of claims 20 or 21, characterized in that the substrate is wood, plywood, plastic, or metal.

23. Coated substrate according to one of claims 20 to 22, characterized in that the metallic layer exhibits a layer thickness of 0.01 to 1 μm and the protective varnish layer(s) together exhibit a layer thickness of 5 to 50 μm.

24. Coated substrate according to one of claims 20 to 23, characterized in that the base varnish layer exhibits a layer thickness of 5 to 30 μm.

25. Method for adhesively coating substrates with corrodible optical layers, in which
(a) at least one base varnish layer is applied to the substrate,
(b) the at least one base varnish layers is dried thoroughly following its application,
(c) a corrodible optical layer is applied,
(d) the substrate coated according to the preceding steps (a), (b) and (c) is heated, and finally
(e) at least one protective varnish layer containing a single-component protective varnish, such as a nano-varnish, and/or a two-component protective varnish is applied
characterized in that a temperature of 120° C. is not exceeded in any process step.

26. Method, especially according to claim 25, in which
(a) at least one base varnish layer is applied to the substrate,
(b) the at least one base varnish layer is dried thoroughly following its application,
(c) a corrodible optical layer is applied,
(d) the substrate coated according to the preceding steps (a), (b) and (c) is heated,
(e1) a layer-forming agent containing either at least one component A or at least one component B is applied to the at least one corrodible optical layer, wherein
component A is a protective varnish and component B is a hardener component, and finally, in a process step
(e2) at least one protective varnish layer containing a single-component protective varnish, such as a nano-varnish, and/or a two-component protective varnish is applied
characterized in that a temperature of 120° C is not exceeded in any process step.

27. Method according to one of claims 25 or 26, characterized in that the drying of the base varnish layer according to process step (b) is air or kiln drying and/or UV hardening of at least 5 minutes.

28. Method according to one of claims 25 to 27, characterized in that an air and/or kiln drying of the protective varnish layer or of the layer applied in accordance with process step (e1) of at least 1 minute in duration or a UV hardening of the protective varnish layer takes place.

29. Method according to one of claims 25 to 28, characterized in that the substrate is wood, plywood, plastic, or metal.

30. Method according to one of claims 25 to 29, characterized in that the substrate is a plastic selected from the class [consisting of] acrylonitrilebutadiene-styrene (ABS), polystyrene (PS), polypropylene (PP), polycarbonate (PC), polymethylmethacrylate (PMMA), polyamide (PA), polyvinylchloride (PVC), polybutylenterephthalate (PBTB), polyphenylene oxide(PPO), polyurethane RIM (PUR-RIM), PP-EPDM or GF-UP.

31. Method according to one of claims 25 to 30, characterized in that, according to process step (d), heating is performed at a temperature of between 50 and 80° C., preferably for at least 10 minutes.

32. Method according to one of claims 25 to 31, characterized in that a mixture is applied as a protective varnish that contains, in addition to protective varnish and hardener, at least one colorant component.
